(19) United States
(12) Patent Application Publication
(10) Pub. No.: US 2018/0276206 A1
(43) Pub. Date: Sep. 27, 2018

(54) SYSTEM AND METHOD FOR UPDATING A KNOWLEDGE REPOSITORY

(71) Applicant: HCL Technologies Limited, Noida (IN)

(72) Inventors: Navin SAINI, Noida (IN); Gourik Kumar BORAH, Noida (IN)

(21) Appl. No.: 15/917,417

(22) Filed: Mar. 9, 2018

(30) Foreign Application Priority Data
Mar. 23, 2017 (IN) 201711010249

(51) Int. Cl. G06F 17/30

(52) U.S. Cl. CPC G06F 17/30002; G06F 17/30011

(57) ABSTRACT

The present disclosure relates to system(s) and method(s) for updating a knowledge repository. The system is configured to receive a new document. Further, the system is configured to identify a second set of historical documents from a knowledge repository based on comparison of a set of current tokens present in the new document and a set of historical tokens associated with each historical document from the knowledge repository. Furthermore, the system is configured to generates a similarity score corresponding to each historical document by comparing the current pattern of occurrence, associated with each current token, with a historical pattern of occurrence, associated with a historical token corresponding to the current token. Further, the system is configured to update the knowledge repository with the new document by comparing the similarity score corresponding to each historical document from the second set of historical documents with a pre-defined threshold value.

### CROSS-REFERENCE TO RELATED APPLICATIONS AND PRIORITY

This present application claims benefit from Indian Complete Patent Application No 201711010249 filed on 23 Mar. 2017, the entirety of which is hereby incorporated by reference.

### TECHNICAL FIELD

The present disclosure in general relates to the field of data processing. More particularly, the present invention relates to a system and method for updating a knowledge repository.

### BACKGROUND

Knowledge Management Systems are widely used across IT Organizations in order to keep human resources updated with the latest development in the field of Information technology. A large number of In-house training courses are based on the documents maintained in the Knowledge Management System. The Knowledge Management Systems enable users to upload new documents which may help other users of the Knowledge Management System to develop new skills.

At times, users may upload a new document/an article, to the Knowledge Management System, similar to the already existing document in the knowledge repository. In such a situation, it is difficult to identify if the document to be uploaded is already available in the knowledge management system as a part of another document. In such a situation, uploading the new document results in duplication of knowledge in the Knowledge Management System, as well as wastage of memory space. Such duplicate documents also lead to confusion while referring to the information maintained by the Knowledge Management System. Currently, available solutions for duplicate document identification are based on word to word comparison, which is a time consuming process, specifically when there are thousands of documents stored in the Knowledge Management System.

### SUMMARY

This summary is provided to introduce aspects related to a system and method for updating a knowledge repository and the aspects are further described below in the detailed description. This summary is not intended to identify essential features of the claimed subject matter nor is it intended for use in determining or limiting the scope of the claimed subject matter.

In one embodiment, a method for updating a knowledge repository is illustrated. The method may comprise maintaining, by a processor, a knowledge repository. The knowledge repository may be configured to store a first set of historical documents, a set of historical tokens associated with each historical document from the first set of historical documents, and a historical pattern of occurrence associated with each historical token. Further, the method may comprise receiving, by the processor, a new document based on inputs provided by a user. Upon receiving the new document, the method may comprise extracting, by the processor, a set of current tokens present in the new document and a current pattern of occurrence associated with each current token from the set of current tokens. Further, the method may comprise identifying, by the processor, a second set of historical documents from the first set of historical documents stored in the knowledge repository. In one embodiment, the second set of historical documents may be identified based on comparison of the set of current tokens and the set of historical tokens associated with each historical document from the first set of historical documents. The method may further comprise generating, by the processor, a similarity score corresponding to each historical document, from the second set of historical documents. In one embodiment, the similarity score corresponding to each historical document, from the second set of historical documents, may be generated by identifying a historical token, from the historical document, corresponding to each current token from the set of current tokens, and comparing the current pattern of occurrence, associated with each current token from the set of current tokens, with a historical pattern of occurrence associated with the corresponding historical token from the set of historical tokens. Once the similarity score corresponding to each historical document from the second set of historical documents is determined, the method may comprise updating, by the processor, the knowledge repository with the new document. In one embodiment, the knowledge repository may be updated based on comparison of the similarity score corresponding to each historical document from the second set of historical documents with a pre-defined threshold value.

In another embodiment, a system for updating a knowledge repository is illustrated. The system comprises a memory and a processor coupled to the memory, further the processor may execute programmed instructions stored in the memory. In one embodiment, the processor may execute programmed instructions stored in the memory for maintaining a knowledge repository. The knowledge repository may be configured to store a first set of historical documents, a set of historical tokens associated with each historical document from the first set of historical documents, and a historical pattern of occurrence associated with each historical token. Further, the processor may execute programmed instructions stored in the memory for receiving a new document based on inputs provided by a user. Once the new document is received, the processor may execute programmed instructions for extracting a set of current tokens, present in the new document, and a current pattern of occurrence, associated with each current token from the set of current tokens. Further, the processor may execute programmed instructions stored in the memory for identifying a second set of historical documents from the first set of historical documents. In one embodiment, the second set of historical documents may be identified based on comparison of the set of current tokens and the set of historical tokens associated with each historical document from the first set of historical documents. The processor may further execute programmed instructions stored in the memory for generating a similarity score corresponding to each historical document, from the second set of historical documents. In one embodiment, the similarity score corresponding to each historical document may be generated by identifying a historical token, from the historical document, corresponding to each current token, from the set of current tokens and comparing the current pattern of occurrence, associated with each current token from the set of current tokens, with a historical pattern of occurrence associated with the corresponding historical token from the set of historical tokens. Upon generating the similarity score corresponding to each historical document, the processor may execute programmed instructions stored in the memory for updating the knowledge repository with the new document. In one embodiment, the knowledge repository may be updated based on comparison of the similarity score corresponding to each historical document from the second set of historical documents with a pre-defined threshold value.

In yet another embodiment, a computer program product having embodied computer program for updating a knowledge repository is disclosed. The program may comprise a program code for maintaining a knowledge repository. The knowledge repository may be configured to store a first set of historical documents, a set of historical tokens associated with each historical document from the first set of historical documents, and a historical pattern of occurrence associated with each historical token. Further, the program may comprise a program code for receiving a new document based on inputs provided by a user. Once the new document is received, the program may comprise a program code for extracting a set of current tokens, present in the new document, and a current pattern of occurrence, associated with each current token from the set of current tokens. Further, the program may comprise a program code for identifying a second set of historical documents from the first set of historical documents. In one embodiment, the second set of historical documents may be identified based on comparison of the set of current tokens and the set of historical tokens associated with each historical document from the first set of historical documents. Further, the program may comprise a program code for generating a similarity score corresponding to each historical document, from the second set of historical documents. In one embodiment, the similarity score corresponding to each historical document may be generated by identifying a historical token, from the historical document, corresponding to each current token, from the set of current tokens and comparing the current pattern of occurrence, associated with each current token from the set of current tokens, with a historical pattern of occurrence associated with the corresponding historical token from the set of historical tokens. Upon generating the similarity score corresponding to each historical document, the program may comprise a program code for updating the knowledge repository with the new document. In one embodiment, the knowledge repository may be updated based on comparison of the similarity score corresponding to each historical document from the second set of historical documents with a pre-defined threshold value.

### BRIEF DESCRIPTION OF DRAWINGS

The detailed description is described with reference to the accompanying figures. In the figures, the left-most digit(s) of a reference number identifies the figure in which the reference number first appears. The same numbers are used throughout the drawings to refer like features and components.

FIG. 1 illustrates a network implementation of a system for updating a knowledge repository, in accordance with an embodiment of the present subject matter.

FIG. 2 illustrates the system for updating a knowledge repository, in accordance with an embodiment of the present subject matter.

FIG. 3 illustrates a method for updating a knowledge repository, in accordance with an embodiment of the present subject matter.

FIG. 4A illustrates a current pattern of occurrence associated with a current token present in a new document.

FIG. 4B illustrates a historical pattern of occurrence, associated with a historical token corresponding to the current token.

### DETAILED DESCRIPTION

Some embodiments of the present disclosure, illustrating all its features, will now be discussed in detail. The words “maintaining”, “receiving”, “extracting”, “identifying”, “generating”, and “updating”, and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any systems and methods similar or equivalent to those described herein can be used in the practice or testing of embodiments of the present disclosure, the exemplary, systems and methods for updating a knowledge repository are now described. The disclosed embodiments of the system and method for updating the knowledge repository are merely exemplary of the disclosure, which may be embodied in various forms.

Various modifications to the embodiment will be readily apparent to those skilled in the art and the generic principles herein may be applied to other embodiments. However, one of ordinary skill in the art will readily recognize that the present disclosure for updating a knowledge repository is not intended to be limited to the embodiments illustrated, but is to be accorded the widest scope consistent with the principles and features described herein.

The present subject matter relates to a system and method for updating a knowledge repository. In one embodiment, a new document may be received by the system. The new document may be received from a user device or any external data sources. Further, a second set of historical documents may be identified from a first set of historical documents stored in a knowledge repository by comparing a set of current tokens, present in the new document, and a set of historical tokens, associated with each historical document, from the first set of historical documents. Further to the identification of the second set of historical documents, a current pattern of occurrence, associated with each current token, may be compared with a historical pattern of occurrence, associated with a historical token corresponding to the current token. Upon comparing the current pattern of occurrence and the historical pattern of occurrence, a similarity score, corresponding to each historical document from the second set of historical documents, may be generated. Further, the knowledge repository may be updated with the new document based on comparison of the similarity score corresponding to each historical document with a pre-defined threshold value.

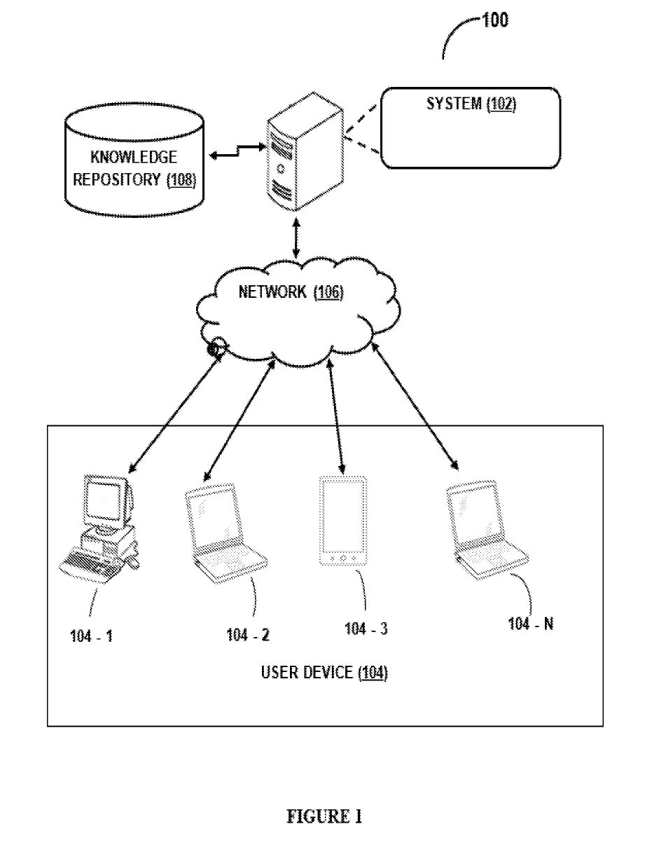

Referring now to FIG. 1, a network implementation 100 of a system 102 for updating a knowledge repository is disclosed. Although the present subject matter is explained considering that the system 102 is implemented on a server, it may be understood that the system 102 may also be implemented in a variety of computing systems, such as a laptop computer, a desktop computer, a notebook, a workstation, a mainframe computer, a server, a network server, and the like. In one implementation, the system 102 may be implemented in a cloud-based environment. It will be understood that the system 102 may be accessed by multiple users through one or more user devices 104-1, 104-2 . . . 104-N, collectively referred to as user device 104 hereinafter, or applications residing on the user device 104. Examples of the user device 104 may include, but are not limited to, a portable computer, a personal digital assistant, a handheld device, and a workstation. The user device 104 may be communicatively coupled to the system 102 through a network 106.

In one implementation, the network 106 may be a wireless network, a wired network or a combination thereof. The network 106 may be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further, the network 106 may include a variety of network devices, including routers, bridges, servers, computing devices, storage devices, and the like.

In one embodiment, the system 102 may maintain a knowledge repository 108. The knowledge repository 108 may be configured to store a first set of historical document, a set of historical tokens associated with each historical document, and a historical pattern of occurrence associated with each historical token from the set of historical tokens. In one example, the system 102 may generate a historical token table, corresponding to each historical document, in the knowledge repository 108. The historical token table, corresponding to each historical document, may comprise the set of historical tokens, historical number of occurrence of each historical token, historical position of occurrence of each historical token in the historical document, and the historical pattern of occurrence associated with each historical token.

Further, the system 102 may receive a new document from a user device 104 or any external data sources based on inputs provided by a user. Once the new document is received, the system 102 may extract a set of current tokens associated with the new document, and a current pattern of occurrence associated with each current token. In one example, the system 102 may generate a current token table corresponding to the new document. The current token table may comprise the set of current tokens, current number of occurrence of each current token, current position of occurrence of each current token, and the current pattern of occurrence associated with each current token.

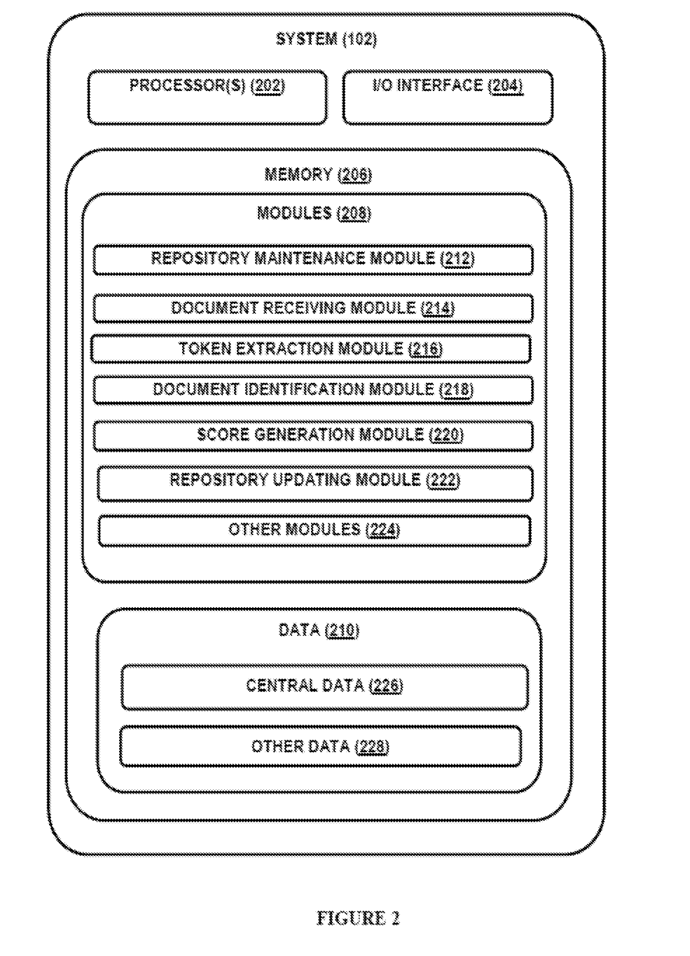

Furthermore, the system 102 may identify a second set of historical documents from the first set of historical documents stored in the knowledge repository 108. In one embodiment, the second set of historical documents may be identified based on comparison of the set of current token and the set of historical tokens, associated with each historical document from the first set of historical documents. Further, the set of current tokens may be a subset of the set of historical tokens, associated with each historical document from the second set of historical documents. Further, the system 102 may generate a similarity score corresponding to each historical document from the second set of historical documents. The similarity score may indicate similarity between the historical document and the new document. In one embodiment, a historical token, from the historical document, corresponding to each current token, from the set of current tokens, may be identified. Further, the current pattern of occurrence, associated with each current token from the set of current tokens, may be compared with a historical pattern of occurrence, associated with a historical token corresponding to the current token. Furthermore, the similarity score may be determined based on the comparison of the current pattern of occurrence and the historical pattern of occurrence. The system 102 may further update the knowledge repository 108 with the new document. In one embodiment, the knowledge repository 108 may be updated based on comparing the similarity score corresponding to each historical document with a pre-defined threshold value. In one embodiment, the knowledge repository 108 may be updated when the similarity score is less than or equal to the pre-defined threshold value. The system 102 for updating a knowledge repository is further elaborated with respect to the FIG. 2.

Referring now to FIG. 2, the system 102 for updating a knowledge repository is illustrated in accordance with an embodiment of the present subject matter. In one embodiment, the system 102 may include at least one processor 202, an input/output (I/O) interface 204, and a memory 206. The at least one processor 202 may be implemented as one or more microprocessors, microcomputers, microcontrollers, digital signal processors, central processing units, state machines, logic circuitries, and/or any devices that manipulate signals based on operational instructions. Among other capabilities, at least one processor 202 may be configured to fetch and execute computer-readable instructions stored in the memory 206.

The I/O interface 204 may include a variety of software and hardware interfaces, for example, a web interface, a graphical user interface, and the like. The I/O interface 204 may allow the system 102 to interact with the user directly or through the user device 104. Further, the I/O interface 204 may enable the system 102 to communicate with other computing devices, such as web servers and external data servers (not shown). The I/O interface 204 may facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 206 may include modules 208 and data 210.

The modules 208 may include routines, programs, objects, components, data structures, and the like, which perform particular tasks, functions or implement particular abstract data types. In one implementation, the module 208 may include a repository maintenance module 212, a document receiving module 214, a token extraction module 216, a document identification module 218, a score generation module 220 a repository updating module 222 and other modules 224. The other modules 224 may include programs or coded instructions that supplement applications and functions of the system 102.

The data 210, amongst other things, serve as a repository for storing data processed, received, and generated by one or more of the modules 208. The data 210 may also include a central data 226, and other data 228. In one embodiment, the other data 228 may include data generated as a result of the execution of one or more modules in the other module 224.

In one implementation, a user may access the system 102 via the I/O interface 204. The user may be registered using the I/O interface 204 in order to use the system 102. In one aspect, the user may access the I/O interface 204 of the system 102 for obtaining information, providing input information or configuring the system 102.

In one embodiment, the repository maintenance module 212 may be configured to maintain a knowledge repository 108. In one embodiment, the knowledge repository 108 may store a first set of historical documents, a set of historical tokens associated with each historical document, and a historical pattern of occurrence associated with each historical token. In one example, a historical document may be a test document, a web page, an online blog and the like.

In another embodiment, the repository maintenance module 212 may generate a historical token table, corresponding to each historical document, in the knowledge repository 108. The historical token table may comprise the set of historical tokens, associated with each historical document, historical position of occurrence of each historical token, and historical number of occurrence of each historical token, the historical pattern of occurrence, associated with each historical token. In one example, each historical token, from the set of historical tokens, may correspond to keyword corresponding to the first set of historical documents. The historical position of occurrence of each historical token may correspond to positions of the historical token in the historical document. The number of occurrence of each historical token may correspond to number of times the historical token may have occurred in the historical document. Further, the historical pattern of occurrence of a historical token, from the set of historical tokens, may correspond to number of words between consecutive occurrences of the historical token in the historical document. In one example, the historical pattern of occurrence of the historical token may be referred as a distance between consecutive historical positions of the historical token in the historical document.

Further, the document receiving module 214 may receive a new document based on inputs provided by the user. The new document may be received from the user device 104 or any external data sources. In one example, the new document may be a text document corresponding to an article, a text paragraph, a brochure and the like. The document receiving module 214 may further store the new document in the central data 226.

Once the new document is received, the token extraction module 216 may extract a set of current tokens present in the new document, a current pattern of occurrence, associated with each current token, and the like. In one embodiment, the token extraction module 216 may generate a current token table corresponding to the new document. The current token table may comprise the set of current tokens, current number of occurrence of each current token, current position of occurrence of each current token, the pattern of occurrence, associated with each current token, and the like. In one example, each current token, from the set of current tokens, may correspond to keyword corresponding to the new document. The current number of occurrence of the current token may correspond to number of times the current token may have occurred in the new document. The current position of occurrence of the current token may correspond to positions of the current token in the new document. Further, the current pattern of occurrence, associated with the current token, from the set of current tokens, may correspond to number of words between consecutive occurrences of the current token in the new document. In one example, the current pattern of occurrence of the current token may be referred as a distance between consecutive current positions of the current token in the new document.

Upon extracting the set of current tokens, the document identification module 218 may compare the set of current tokens and the set of historical tokens, associated with each historical documents, from the first set of historical documents. Upon comparing the set of current tokens and the set of historical tokens, the document identification module 218 may identify a second set of historical documents, from the first set of historical documents, stored in the knowledge repository 108. In one embodiment, the set of current tokens may be a subset of the set of historical tokens, associated with each historical document, from the second set of historical documents. In one example, the document identification module 218 may also identify the historical token table, corresponding to each historical document from the second set of historical documents.

In one example, the document identification module 218 may receive a query from the user of the user device 104. Upon receiving the query, the documents identification module 218 may identify the second set of historical documents from the first set of historical documents stored in the knowledge repository 108.

Once the second set of historical documents is identified, the score generation module 220 may identify a historical token, from a historical document of the second set of historical documents, corresponding to each current token from the set of current tokens. Upon identification of the historical token, the score generation module 220 may compare the current pattern of occurrence, associated with each current token from the set of current tokens, with a historical pattern of occurrence, associated with the historical token corresponding to the current token, from the historical document.

In one example, the current pattern of occurrence, associated with the set of current tokens may be referred to as a first pattern of occurrence, a second pattern of occurrence and the like. In one embodiment, the score generation module 220 may pick up the first pattern of occurrence, associated with a current token from the set of current tokens. Further, the score generation module 220 may compare the first pattern of occurrence, associated with the current token, and the historical pattern of occurrence, associated with the historical token corresponding to the current token, from the set of historical tokens, to determine similarity between the first pattern of occurrence, associated with the current token, and the historical pattern of occurrence. In a similar manner, similarity between the pattern of occurrence may be compared for other current tokens to determine similarity score between the new document and each of the historical documents.

Further, the score generating module 220 may determine a similarity score corresponding to the historical document, from the second set of historical documents. In one embodiment, the similarity score may be based on the similarity between the pattern of occurrence of each current token from the new document and the historical pattern of occurrence, associated with the corresponding historical token. In one embodiment, the similarity score corresponding to each historical document may indicate similarity between the historical document and the new document. The score generation module 220 may further display a table to the user. The table may comprise name of each historical document, from the second set of historical documents, the similarity score, corresponding to each historical document, and the like.

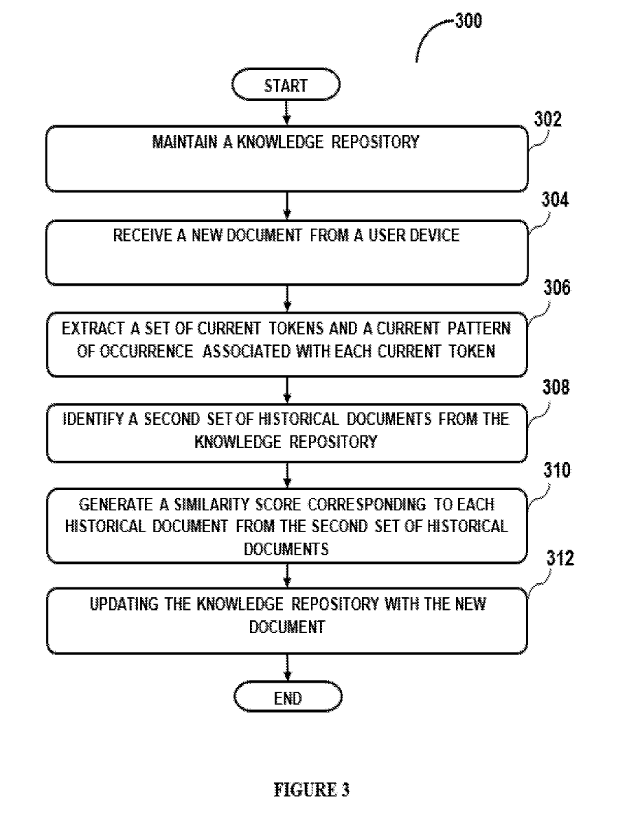

Further, the repository updating module 222 may update the knowledge repository 108 with the new document. In one embodiment, the knowledge repository 108 may be updated based on comparison of the similarity score, corresponding to each historical document, with a pre-defined threshold value. In another embodiment, the repository updating module 222 may update the knowledge repository 108 with the new document when the similarity score is less than or equal to the pre-defined threshold value. In one example, the pre-defined threshold value may be defined by the user. Further, the method for updating a knowledge repository is further elaborated with respect to the block diagram of FIG. 3.

Referring now to FIG. 3, a method 300 for updating a knowledge repository, is disclosed in accordance with an embodiment of the present subject matter. The method 300 may be described in the general context of computer executable instructions. Generally, computer executable instructions can include routines, programs, objects, components, data structures, procedures, modules, functions, and the like, that perform particular functions or implement particular abstract data types. The method 300 may also be practiced in a distributed computing environment where functions are performed by remote processing devices that are linked through a communications network. In a distributed computing environment, computer executable instructions may be located in both local and remote computer storage media, including memory storage devices.

The order in which the method 300 is described is not intended to be construed as a limitation, and any number of the described method blocks can be combined in any order to implement the method 300 or alternate methods. Additionally, individual blocks may be deleted from the method 300 without departing from the spirit and scope of the subject matter described herein. Furthermore, the method 300 can be implemented in any suitable hardware, software, firmware, or combination thereof. However, for ease of explanation, in the embodiments described below, the method 300 may be considered to be implemented in the above described system 102.

At block 302, a knowledge repository 108 may be maintained. In one embodiment, the repository maintenance module 212 may be configured to maintain the knowledge repository 108. In one embodiment, the knowledge repository 108 may store a first set of historical documents, a set of historical tokens associated with each historical document, and a historical pattern of occurrence associated with each historical token. In one example, a historical document may be a test document, a web page, an online blog and the like.

In another embodiment, a historical token table, corresponding to each historical document, may be generated in the knowledge repository 108. The historical token table may comprise the set of historical tokens, associated with each historical document, historical position of occurrence of each historical token, and historical number of occurrence of each historical token, the historical pattern of occurrence, associated with each historical token. In one example, each historical token, from the set of historical tokens, may correspond to keyword corresponding to the first set of historical documents. The historical position of occurrence of each historical token may correspond to positions of the historical token in the historical document. The number of occurrence of each historical token may correspond to number of times the historical token may have occurred in the historical document. Further, the historical pattern of occurrence of a historical token, from the set of historical tokens, may correspond to number of words between consecutive occurrences of the historical token in the historical document. In one example, the historical pattern of occurrence of the historical token may be referred as a distance between consecutive historical positions of the historical token in the historical document.

At block 304, a new document may be received based on inputs provided by a user. In one embodiment, the document receiving module 214 may receive the new document based on inputs provided by the user. The new document may be received from the user device 104 or any external data sources. In one example, the new document may be a text document corresponding to an article, a text paragraph, a brochure and the like.

At block 306, a set of current tokens present in the new document, and a current pattern of occurrence, associated with each current token may be extracted. In one embodiment, the token extraction module 216 may extract the set of current tokens present in the new document, the current pattern of occurrence, associated with each current token, and the like. Further, a current token table corresponding to the new document may be generated. The current token table may comprise the set of current tokens, current number of occurrence of each current token, current position of occurrence of each current token, the pattern of occurrence, associated with each current token, and the like. In one example, each current token, from the set of current tokens, may correspond to keyword corresponding to the new document. The current number of occurrence of the current token may correspond to number of times the current token may have occurred in the new document. The current position of occurrence of the current token may correspond to positions of the current token in the new document. Further, the current pattern of occurrence, associated with the current token, from the set of current tokens, may correspond to number of words between consecutive occurrences of the current token in the new document. In one example, the current pattern of occurrence of the current token may be referred as a distance between consecutive current positions of the current token in the new document.

At block 308, the set of current tokens may be compared with the set of historical tokens, associated with each historical document, from the first set of historical tokens. In one embodiment, the document identification module 218 may compare the set of current tokens and the set of historical tokens, associated with each historical documents, from the first set of historical documents. Further, a second set of historical documents, from the first set of historical documents, may be identified. The second set of historical documents may be identified based on comparison of the set of current tokens and the set of historical tokens. In one embodiment, the set of current tokens may be a subset of the set of historical tokens, associated with each historical document, from the second set of historical documents. In one example, the historical token table, corresponding to each historical document from the second set of historical documents, may be identified.

At block 310, a historical token, from a historical document of the second set of historical documents, corresponding to each current token from the set of current tokens, may be identified. In one embodiment, the score generation module 220 may identify the historical token, corresponding to each current token from the set of current tokens. Further, the current pattern of occurrence, associated with each current token from the set of current tokens, may be compared with a historical pattern of occurrence, associated with the historical token corresponding to the current token, from the historical document.

In one example, the current pattern of occurrence, associated with the set of current tokens may be referred to as a first pattern of occurrence, a second pattern of occurrence and the like. In one embodiment, similarity between the pattern of occurrence may be compared for other current tokens to determine similarity score between the new document and each of the historical documents from the second set of historical documents.

Further, a similarity score corresponding to the historical document, from the second set of historical documents may be determined. In one embodiment, the similarity score may be based on the similarity between the pattern of occurrence of each current token from the new document and the historical pattern of occurrence, associated with the historical token corresponding to the current token. In one embodiment, the similarity score corresponding to each historical document may indicate similarity between the historical document and the new document.

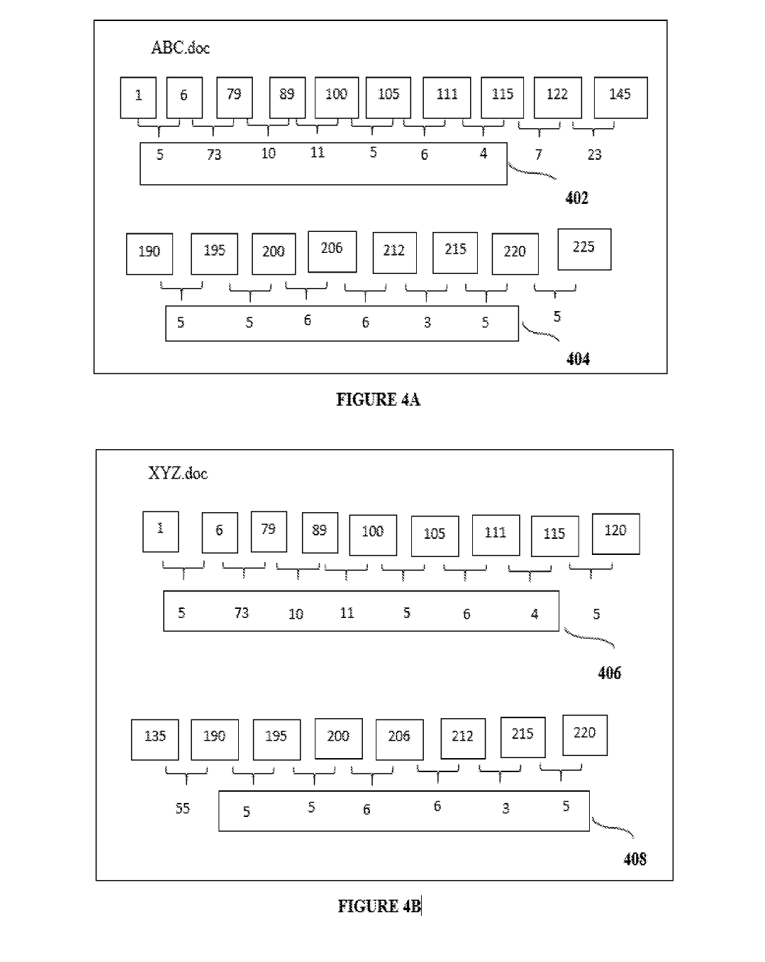

At block 312, the knowledge repository 108 may be updated with the new document. In one embodiment, the repository updating module 222 may update the knowledge repository 108 with the new document. The knowledge repository 108 may be updated based on comparison of the similarity score, corresponding to each historical document, with a pre-defined threshold value. The knowledge repository 108 may be updated with the new document when the similarity score is less than or equal to the pre-defined threshold value. In one example, the pre-defined threshold value may be defined by the user. Further, a current pattern of occurrence associated with a current token present in a new document is elaborated with FIG. 4A and a historical pattern of occurrence, associated with a historical token corresponding to the current token, is elaborated with FIG. 4B.

In one exemplary embodiment, a new document (ABC.doc) may be received by the document receiving module 214. The token extraction module 216 may analyse ABC.doc file to generate a current token table as represented in a table 1.

TABLE 1
Current token table

| Current | Current Number | |
|---|---|---|
| Token | of occurrence | Current Position of occurrence |
| CDMA | 28 | 1, 6, 79, 89, 100, 105 . . . |
| TELECOM | 12 | 8, 11, 22, 24 . . . |

The table 1 may store the set of current tokens associated with the new document and the current number of occurrence associated with each current token ((a) CDMA-28, and (b) TELECOM-12). Further, referring to the table 1, the current position of occurrence of each current token may be (a) CDMA-(1, 6, 79, 89, 100, 105 . . . ), and (b) TELECOM-(8, 11, 22, 24 . . . ).

Further, the document identification module 218 may identify a historical document XYZ.doc from the knowledge repository 108 based on comparing the set of current tokens, and a set of historical tokens associated with the first set of historical documents stored in a knowledge repository 108. In one example, the document identification module 218 may receive a query, from the user, to identify the historical document. The query may be “return all docs having CDMA occurrences >=28 & Telecom >=12”.

Upon identifying the historical document (i.e. XYZ.doc), the document identification module 218 may also generate a historical token table corresponding to the historical document. The table 2 may correspond to the historical token table.

TABLE 2
Historical token table

| Historical | Historical Number | |
|---|---|---|
| Token | of occurrence | Historical Position of occurrence |
| CDMA | 50 | 1, 6, 79, 89, 100, 105, 111, 115 . . . |
| TELECOM | 30 | 2, 5, 78, 87, 99, 107, 110, 121, 123 |
| WCDMA | 20 | 4, 9, 45, 67, 82, 109 . . . |

Referring to the table 2, the historical tokens associated with the document and the historical number of occurrence of the historical token may be (a) CDMA-50, (b) TELECOM-30, and (c) WCDMA-20. Further, referring to the table 2, the historical position of occurrence of each historical token may be (a) CDMA-(1, 6, 79, 89, 100, 105, 111, 115 . . . ), (b) TELECOM-(2, 5, 78, 87, 99, 107, 110, 121, 123 . . . ), and (c) WCDMA-(4, 9, 45, 67, 82, 109 . . . ).

Referring now to FIG. 4A, the score generating module 220 may pick up a pattern of occurrence corresponding to a first current token (CDMA)-5, 73. Further, the score generating module may search for the pattern of occurrence corresponding to CDMA in the historical document. Referring now to FIG. 4B, the score generating module 220 may identify the pattern of occurrence (5, 73) corresponding to CDMA in the historical document. The score generating module 220 may further identify the pattern of occurrence 402 (5, 73, 10, 11, 5, 6, 4, 5) corresponding to CDMA similar to the historical pattern of occurrence 406 (5, 73, 10, 11, 5, 6, 4, 5) corresponding to CDMA from the historical document (XYZ.doc). The score generating module 220 identifies that the pattern of occurrence (5, 73, 10, 11, 5, 6, 4, 7, 23, 5, 5, 6, 6, 3, 5, 5) in the new document is partially similar to the pattern of occurrence (5, 73, 10, 11, 5, 6, 4, 5, 5, 55, 5, 5, 6, 6, 3, 5) of the historical token (CDMA) in the historical document. Further, the score generating module 220 may further identify the pattern of occurrence 404 corresponding to CDMA similar to the historical pattern of occurrence 408 corresponding to CDMA from the historical document (XYZ.doc).

Further, number of the current pattern of occurrences for the first current token (CDMA) is similar to the historical pattern of occurrence for the historical token (CDMA) at 13 consecutive positions. The total number of occurrence of the current token in the new document is considered as 28. Hence, the percentage similarity between the current pattern of occurrence and the historical pattern of occurrence is 46.8%. Furthermore, the score generating module 220 may determine similarity between historical pattern of occurrences and a current pattern of occurrence associated with second current token (TELECOM). Further, the score generating module 220 may determine the similarity score corresponding to the historical document (XYZ.doc), based on the similarity of the current pattern of occurrence of the current tokens (CDMA and TELECOM) and the historical pattern of occurrence, associated with the historical tokens (CDMA and TELECOM).

Further, the repository updating module 222 may update the knowledge repository 108 with the new document, when the similarity score corresponding to the historical document is less than or equal to the pre-defined threshold value.

Although implementations for systems and methods for updating a knowledge repository have been described, it is to be understood that the appended claims are not necessarily limited to the specific features or methods described. Rather, the specific features and methods are disclosed as examples of implementations for updating the knowledge repository.

We claim:

1. A method for updating a knowledge repository, the method comprises:
maintaining, by a processor, a knowledge repository, wherein the knowledge repository stores a first set of historical documents, a set of historical tokens associated with each historical document from the first set of historical documents and a historical pattern of occurrence associated with each historical token;
receiving, by the processor, a new document;
extracting, by the processor, a set of current tokens present in the new document and a current pattern of occurrence associated with each current token from the set of current tokens;
identifying, by the processor, a second set of historical documents from the first set of historical documents based on comparison of the set of current tokens and the set of historical tokens associated with each historical document from the first set of historical documents;
generating, by the processor, a similarity score corresponding to each historical document, from the second set of historical documents, wherein the similarity score corresponding to each historical document is generated by
identifying a historical token, from the historical document, corresponding to each current token from the set of current tokens, and
comparing the current pattern of occurrence, associated with each current token from the set of current tokens, with a historical pattern of occurrence, associated with the corresponding historical token from the set of historical tokens; and
updating, by the processor, the knowledge repository with the new document based on comparison of the similarity score corresponding to each historical document from the second set of historical documents with a pre-defined threshold value.

2. The method of claim 1, wherein each historical token corresponds to keyword in the historical document and each current token corresponds to keyword in the new document.

3. The method of claim 1, wherein the historical pattern of occurrence of the historical token corresponds to number of words between consecutive occurrences of the historical token in the historical document, and the current pattern of occurrence corresponds to number of words between consecutive occurrences of the current token in the new document.

4. The method of claim 1, wherein the set of current tokens is a subset of the set of historical tokens associated with each historical document from the second set of historical documents.

5. The method of claim 1, wherein the knowledge repository is updated with the new document when the similarity score is less than or equal to the pre-defined threshold score.

6. A system for updating a knowledge repository, the system comprising:
a memory; and
a processor coupled to the memory, wherein the processor is configured to execute programmed instructions stored in the memory to:
maintain a knowledge repository, wherein the knowledge repository stores a first set of historical documents, a set of historical tokens associated with each historical document from the first set of historical documents and a historical pattern of occurrence associated with each historical token;
receive a new document;
extract a set of current tokens present in the new document and a current pattern of occurrence associated with each current token from the set of current tokens;
identify a second set of historical documents from the first set of historical documents based on comparison of the set of current tokens and the set of historical tokens associated with each historical document from the first set of historical documents;
generate a similarity score corresponding to each historical document, from the second set of historical documents, wherein the similarity score corresponding to each historical document is generated by
identifying a historical token, from the historical document, corresponding to each current token from the set of current tokens, and
comparing the current pattern of occurrence, associated with each current token from the set of current tokens, with a historical pattern of occurrence, associated with the corresponding historical token from the set of historical tokens; and
update the knowledge repository with the new document based on comparison of the similarity score corresponding to each historical document from the second set of historical documents with a pre-defined threshold value.

7. The system of claim 6, wherein each historical token corresponds to keyword in the historical document and each current token corresponds to keyword in the new document.

8. The system of claim 6, wherein the historical pattern of occurrence of the historical token corresponds to number of words between consecutive occurrences of the historical token in the historical document, and the current pattern of occurrence corresponds to number of words between consecutive occurrences of the current token in the new document.

9. The system of claim 6, wherein the set of current tokens is a subset of the set of historical tokens associated with each historical document from the second set of historical documents.

10. The system of claim 6, wherein the knowledge repository is updated with the new document when the similarity score is less than or equal to the pre-defined threshold value.

11. A computer program product having embodied thereon a computer program for updating a knowledge repository, the computer program product comprising:
a computer program for maintaining a knowledge repository, wherein the knowledge repository stores a first set of historical documents, a set of historical tokens associated with each historical document from the first set of historical documents and a historical pattern of occurrence associated with each historical token;
a computer program for receiving a new document;
a computer program for extracting a set of current tokens associated with the new document and a current pattern of occurrence associated with each current token from the set of current tokens;
a computer program for identifying a second set of historical documents from the first set of historical documents based on comparison of the set of current tokens and the set of historical tokens associated with each historical document from the first set of historical documents;
a computer program for generating a similarity score corresponding to each historical document, from the second set of historical documents, wherein the similarity score corresponding to each historical document is generated by
identifying a historical token, from the historical document, corresponding to each current token from the set of current tokens, and
comparing the current pattern of occurrence, associated with each current token from the set of current tokens, with a historical pattern of occurrence, associated with the corresponding historical token from the set of historical tokens; and
a computer program for updating the knowledge repository with the new document based on comparison of the similarity score corresponding to each historical document from the second set of historical documents with a pre-defined threshold value.
